(19) United States
(12) Patent Application Publication
(10) Pub. No.: US 2019/0299917 A1
(43) Pub. Date: Oct. 3, 2019

(54) PASSENGER PROTECTION APPARATUS FOR VEHICLE

(71) Applicant: SUBARU CORPORATION, Tokyo (JP)

(72) Inventor: Isamu NAGASAWA, Tokyo (JP)

(73) Assignee: SUBARU CORPORATION, Tokyo (JP)

(21) Appl. No.: 16/239,858

(22) Filed: Jan. 4, 2019

(30) Foreign Application Priority Data
Mar. 30, 2018 (JP) 2018-068592

(51) Int. Cl. B60R 21/2338; B60R 21/207

(52) U.S. Cl. CPC B60R 21/2338; B60R 2021/23386; B60R 21/207

(57) ABSTRACT

A passenger protection apparatus for a vehicle includes: an airbag configured to protrude to a vehicle compartment from a seat on which a passenger sits at a predetermined position; and a tether having a first end coupled to the airbag at a position inward in a seat width direction, and a second end coupled to an adjacent member or the airbag at a position where the seat is closer to the second end than the first end. A length from the first end to the second end is shorter than a first length from a position at which the first end is coupled to the airbag to the predetermined position or the second end, and also shorter than a second length from the position at which the first end is coupled to the airbag to a front end of the airbag. The first length is shorter than the second length.

### The present application claims priority from Japanese Patent Application No. 2018-068592 filed on Mar. 30, 2018, the entire contents of which are hereby incorporated by reference,

### BACKGROUND

### 1. Technical Field

The present invention relates to a passenger protection apparatus for vehicle,

### 2. Related Art

In order to protect a passenger in a vehicle, an airbag provided in a seat near the passenger has been used. There has been known a side airbag device capable of protecting the head of a passenger including an airbag body deployed between a body side part of the vehicle and a part from the chest to the head of the passenger, and an airbag projecting member deployed to project in front of the face of the passenger from the airbag body, which is disclosed, for example, in in Japanese Unexamined Patent Application Publication No. 2006-008105.

### SUMMARY OF THE INVENTION

An aspect of the present invention provides a passenger protection apparatus for a vehicle including: an airbag configured to protrude to a vehicle compartment from a seat on which a passenger sits or a peripheral member of the seat at a predetermined position; and a tether having a first end and a second end, the first end being coupled to the airbag at a position inward in a seat width direction, and the second end being coupled to an adjacent member adjacent to the airbag or the airbag at a position where the seat is closer to the second end than the first end. A length of the tether from the first end to the second end or the adjacent member is shorter than a first length from a position at which the first end is coupled to the airbag to the predetermined position or the second end, and also shorter than a second length from the position at which the first end is coupled to the airbag to a front end of the air-bag. The first length is shorter than the second length.

### BRIEF DESCRIPTION OF THE DRAWINGS

FIG. 1A is a front view schematically illustrating a passenger protection apparatus according to an example of the present invention;

FIG. 1B is a plan view schematically illustrating the passenger protection apparatus;

FIG. 2A is a schematic view illustrating an airbag of the passenger protection apparatus illustrated in FIG. 1;

FIG. 2B is a schematic view illustrating an airbag of a passenger protection apparatus according to another example;

FIG. 2C is a schematic view illustrating an airbag of a passenger protection apparatus according to another example; and

FIGS. 3A-3C illustrate the deployment of the airbag of the passenger protection apparatus illustrated in FIG. 1.

### DETAILED DESCRIPTION

Hereinafter, an example of the present invention will be described with reference to the drawings. Note that the following description is directed to an illustrative instance of the present invention and not to be construed as limiting to the present invention. Factors including, without limitation, numerical values, shapes, materials, components, positions of the components, and how the components are coupled to each other are illustrative only and not to be construed as limiting to the present invention. Further, elements in the following example which are not recited in a most-generic independent claim of the present invention are optional and may be provided on an as-needed basis. The drawings are schematic and are not intended to be drawn to scale. Throughout the present specification and the drawings, elements having substantially the same function and configuration are denoted with the same reference numerals to avoid any redundant description.

As automated driving technology has been developing, the sitting position and posture of the passenger in the vehicle compartment will increasingly become free. In that case, the seat layout may be different from the past, and therefore it may be difficult to protect the passenger by the conventional airbag provided in a steering or an instrument panel. Accordingly, there is an increasing demand to provide a passenger protection device such as an airbag disposed in the seat. However, it is difficult for conventional side airbag devices to cope with collisions in all directions.

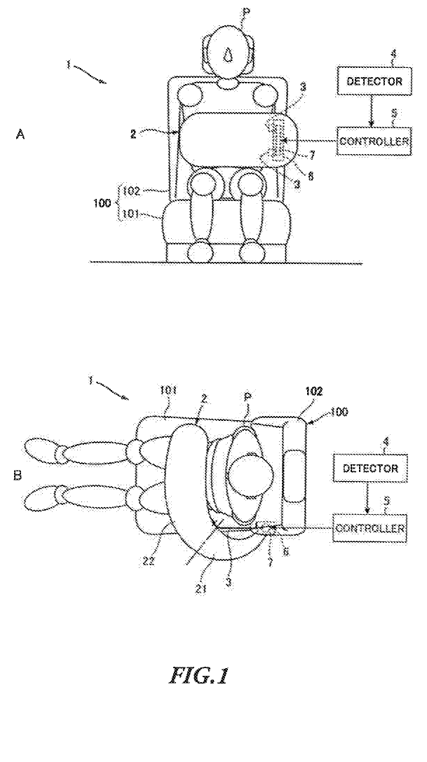

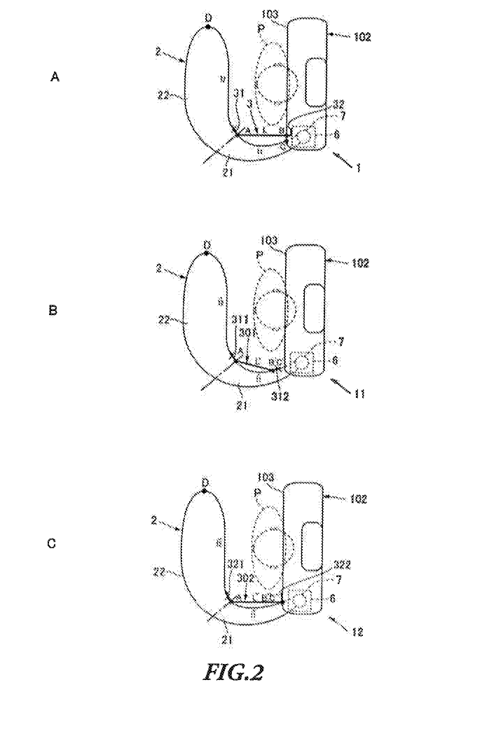

It is desirable to provide a passenger protection apparatus for vehicle capable of protecting a passenger from various types of collisions only by components of the seat on which the passenger sits. FIG. 1A is a front view schematically illustrating a passenger protection apparatus 1 according to an example of the present invention. FIG. 1B is a plan view schematically illustrating the passenger protection apparatus 1. FIG. 2A is a schematic view illustrating an airbag 2 of the passenger protection apparatus 1 illustrated in FIG 1. FIG. 2B is a schematic view illustrating of an airbag 201 of a passenger protection apparatus 11 according to another example. FIG. 20 is a schematic view illustrating of an airbag 202 of a passenger protection apparatus 12 according to another example.

As illustrated in FIGS. 1A-1B, the passenger protection apparatus 1 includes the airbag 2, and a tether 3. In addition, the passenger protection apparatus 1 includes a detector 4 and a controller 5 to deploy the airbag 2.

The airbag 2 is deployed via the surface of a seat 100 on which a passenger P sits. As illustrated in FIG. 1B, the airbag 2 includes a base portion 21 and a front portion 22 which are divided at the coupling position of the airbag 2 to the tether 3. The base portion 21 is disposed on one side of the passenger P, and the front portion 21 is disposed in front of the passenger P. The seat 100 includes a seat cushion 101 on which the passenger P can sit, and a seat back 102 on which the passenger P can lean back. The airbag 2 is made of fabric and has a pouch-shaped body. Before the deployment, the airbag 2 is folded and stored in a storage member 6 disposed in the seat back 102. The airbag 2 is formed in a plate-like shape. In order to deploy the airbag 2, gas generated in an inflator 7 provided in the storage member 6 is injected into the airbag 2. Then, the airbag 2 expands and protrudes from the storage member 6 to tear the surface of the seat back 102, and therefore to deploy in the vehicle compartment. Here, with the present example, the airbag 2 protrudes from the surface of the seat 100. However, this is by no means limiting, and the airbag 2 may protrude from an interior material as a peripheral member of the seat 100.

The tether 3 is a long member made of, for example, the same material as that of the airbag 2. The airbag 2 and the storage member 6 are connected via the tether 3. Before the deployment of the airbag 2, the tether 3 is folded and stored in the storage member 6 together with the airbag 2. How to couple the tether 3 to the airbag 2 and so forth will be described later with reference to FIGS. 2A-2C.

The detector 4 detects or predicts a collision of the vehicle. To be more specific, the detector 4 detects or predicts a collision of the own vehicle with another vehicle or an obstacle, based on the monitoring result of the surrounding environment of the vehicle by a camera or a sensor. The detector 4 can output the detection result to the controller 5. The detector 5 can determine an occurrence of a collision based on the detection of an impact on the own vehicle by, for example, an in-vehicle acceleration sensor. As for the prediction of a collision, it is possible to derive a possibility that another vehicle or an obstacle contacts the own vehicle by combining the result of monitoring another vehicle or an obstacle by a monitoring camera or sensor in the vehicle that monitors the outside of the vehicle with parameters such as the running speed and the direction of the vehicle. Moreover, it is possible to determine whether there is a high or low possibility of a collision based on whether the derived result exceeds a predetermined threshold. The detector 4 may be realized by a combination of a processing unit to analyze the monitoring results and, for example, an in-vehicle camera, a monitoring sensor, or an acceleration sensor.

The controller 5 controls the activation of the inflator 7. To be more specific, the controller 5 activates the inflator 7 based on the detection result outputted from the detector 4. The inflator 7 activated by the controller 5 ignites explosives to generate gas. The controller 5 can output an activation signal to the inflator 7. As the controller 5, for example, an ECU which is an in-vehicle processing unit may be used.

Next, how to couple the tether 3 to the airbag 2 or adjacent members of the passenger protection apparatus 1 will be described with reference to FIGS. 2A-2C.

FIG. 2A schematically illustrates the airbag 2, the tether 3, and the seat back 102 of the passenger protection apparatus 1 illustrated in FIG. 1.

The tether 3 includes a first end 31 coupled to the outer surface of the airbag 2 facing inward in the width direction of the seat 100 (hereinafter “seat width direction”), and a second end 32 coupled to the storage member 6. Here, the storage member 6 is one of a plurality of adjacent members of the airbag 2. The tether 3 is coupled to the airbag 2 by sewing. Alternatively, the tether 3 is coupled to the storage member 6 by adhesion. In FIGS. 2A-2C, “A” denotes a position at which the first end of the tether 3 is coupled to the airbag 2, and “B” denotes a position at which the tether 3 is exposed from the seat surface 103 of the seat back 102. In addition, “C” denotes a position at which the base portion 21 of the airbag 2 which faces inward in the seat width direction is exposed from the seat surface 103, and “D” denotes the front end of the front portion 22. Here, the adjacent members of the airbag 2 may include the seat back 102, the storage member 6 and so forth.

With the present example illustrated in FIG. 2A, a length L of the tether 3 from the first end 31 to the seat surface 103 of the seat back 102 as an adjacent member (distance A to B) is shorter than a first length l₁ of the airbag 2 from the position at which the first end 31 of the tether 3 is coupled to the airbag 2 to the seat surface 103 (distance A to C). In addition, the length L between A and B is shorter than a second length l₂ of the airbag 2 from the position at which the first end 31 of the tether 3 is coupled to the airbag 2 to the front end of the airbag 2 (distance A to D). Moreover, the first length l₁ (distance A to C) is shorter than the second length l₂ (distance A to D).

With another example, both a first end 311 and a second end 312 of a tether 301 may be coupled to the airbag 2 as illustrated in FIG. 2B.

The tether 301 is different from the tether 3 in that the second end 312 of the tether 301 is coupled to the airbag 2, instead of the storage member 6. The second end 312 is coupled to the airbag 2 at a position B′. In addition, in FIG. 2B, the second end 312 of the tether 301 is coupled to the airbag 2 at a position C′, instead of the position C at which the base portion 21 is exposed from the seat surface 103 as illustrated in FIG. 2A. That is, with the present example, B′ and C′ are the same position. Here, the first end 311 of the tether 301 is coupled to the airbag 2 at the position A, and the front end of the front portion 22 is denoted as “D”, which are the same as those in FIG. 2A.

With the present example illustrated in FIG. 2B, a length L′ of the tether 301 from the first end 311 to the second end 312 (distance A to B′) is shorter than a first length l′₁ of the airbag 2 from the position at which the first end 311 of the tether 301 is coupled to the airbag 2 to the second end 312 of the tether 301 coupled to the outer surface of the airbag 2 (distance A to C′) In addition, the length L′ between A and B′ is shorter than a second length l′₂ of the airbag 2 from the position at which the first end 311 of the tether 301 is coupled to the airbag 2 to the front end of the airbag 2 (distance A to D′) Moreover, the first length l′₁ (distance A-C′) is shorter than the second length l′₂ (distance A-D).

With further another example as illustrated in FIG. 2C, a first end 321 of a tether 302 may be coupled to the airbag 2, and a second end 322 may be coupled to the seat back 102 by sewing.

The tether 302 is different from the tether 3 in that the second end 322 of the tether 302 is coupled to the seat surface 103 of the seat back 102, instead of the storage member 6. The second end 322 is coupled to the airbag 2 at a position B″. In addition, in FIG. 2C, the base portion 21 is exposed from the seat surface 103 at a position “C″” which is the same as the position B″. Here, the first end 321 of the tether 302 is coupled to the airbag 2 at the position A, and the front end of the front portion 22 is denoted as “D”, which are the same as those in FIG. 2A.

With the present example illustrated in FIG. 2C, a length L″ of the tether 302 from the first end 321 to the seat surface 103 of the seat back 102 as an adjacent member (distance A to B″) is shorter than a first length l″₁ of the airbag 2 from the position at which the first end 321 of the tether 302 is coupled to the airbag 2 to the seat surface 103 (distance A to C″). In addition, the length L″ between A and B″ is shorter than a second length l″₂ of the airbag 2 from the position at which the first end 321 of the tether 302 is coupled to the airbag 2 to the front end of the airbag 2 (distance A to D). Moreover, the first length l″₁ (distance A to C″) is shorter than the second length l″₂ (distance A-D).

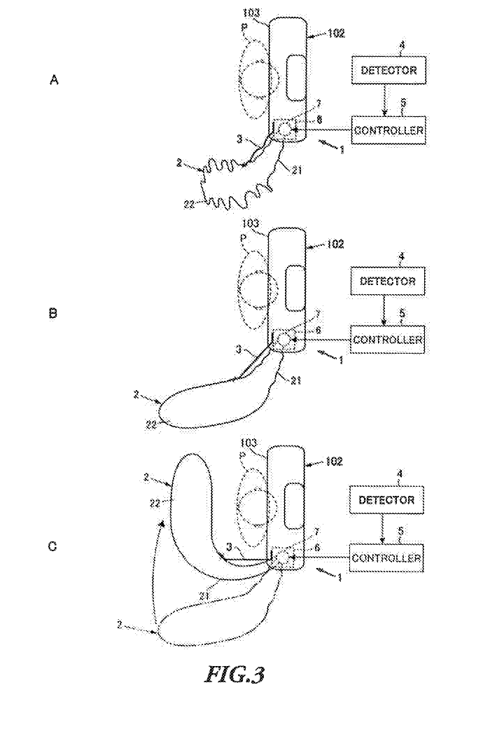

As illustrated in FIGS. 2A-2C, the tether 3 may be coupled to the airbag 2 or the adjacent members in various ways. However, the constant relationship is kept among the tether 3, the first length l″₁ and the second length l″₂ in size throughout FIGS. 2A-2C. As a result, after protruding from the seat back 102, the airbag 2 can be turned inward in the seat width direction. Next, the deployment of the airbag 2 of the passenger protection apparatus l according to the example illustrated in FIGS. 1A-1B and 2A will be described with reference to FIGS. 3A-3C.

FIGS. 3A-3C illustrate the deployment of the airbag 2 of the passenger protection apparatus 1 illustrated in FIGS. 1A-1B. Hereinafter, a sequence of actions to deploy the airbag 2 of the passenger protection apparatus 1 will be described. First, the detector 4 detects or predicts a collision. Upon receiving a signal indicating the detection result by the detector 4, the controller 5 outputs an activation signal to the inflator 7. Upon receiving the activation signal from the controller 5, the inflator 7 ignites explosives to generate gas. The gas generated in the inflator 7 is injected into the airbag 2 to expand the airbag 2, and the expanding airbag 2 tears the seat surface 103 of the seat back 102 and protrudes from the seat back 102. FIG. 3A illustrates the airbag 2 protruding from the seat back 102 in an early stage of the deployment.

FIG. 3A illustrates the airbag 2 in a state where a certain amount of the gas has flowed into the base portion 21, but a little amount of the gas has flowed into the front portion 22. In this case, the tether 3 is loose. The airbag 2 protrudes outward in the seat width direction, toward the front of the seat 100.

Then, the airbag 2 is expanding as illustrated in FIG. 3B. FIG. 3B illustrates the airbag 2 in a state where a certain amount of the gas has flowed into the base portion 21, and the front portion 22 is approximately filled with the gas. At this time, the tether 3 is tensioned to make a straight line between the first end 31 coupled to the outer surface of the airbag 2 facing inward in the seat width direction and the second end 32 coupled to the storage member 6. The airbag 2 illustrated in FIG. 3B protrudes outward in the seat width direction, toward the front of the seat 100 in the same way as FIG. 3A.

The deployment of the airbag 2 progresses from the state illustrated in FIG. 3B to the state illustrated in FIG. 3C where the deployment is completed. The airbag 2 illustrated in FIG. 3C is in a state where both the base portion 21 and the front portion 22 are approximately filled with the gas. When the base portion 21 in the state illustrated in FIG. 3B is changed to the state where the base portion 21 is approximately filled with the gas, the base portion 21 is curved outward in the seat width direction because the length L of the tether 3 is shorter than the first length l₁ of the airbag 2 as described above. By this means, the front portion 22 faces inward in the seat width direction, in addition, the entire airbag 2 is turned inward in the seat width direction from the position B at which the tether 3 is exposed from the seat surface 103 or the position at which the tether 3 is coupled to the storage member 6. Accordingly, the front portion 22 of the airbag 2 deploys in front of the upper body of the passenger P. The airbag 2 protruding outward is turned inward in the seat width direction as illustrated in FIG. 3C, so that the deployment of the airbag 2 is completed,

As illustrated in FIGS. 3A-3C, the airbag 2 protrudes from the seat back 102 at a position outside the upper body of the passenger P in the seat width direction, toward the front of the seat 100, and the front portion 22 is turned inward in the seat width direction by the tether 3. As a result, the airbag 2 deploys front of the upper body of the passenger P. As described above, the second length l₂ of the airbag 2 is longer than the first length l₁ as described above. Therefore, the front portion 22 of the airbag 2 is larger than the base portion 21, and consequently it is possible to increase the area to cover the upper body of the passenger P in the seat width direction.

Accordingly, the airbag 2 protruding from the seat back 102 is deployed to cover the front and the side of the upper body of the passenger P. As a result, it is possible to protect the passenger P from various types of collisions such as a frontal collision, a lateral collision, a rear collision, and an oblique collision only by the components of the seat 100.

If the airbag 2 is pulled by the tether 3 since the early stage of the deployment, the airbag 2 may move in various directions near the passenger P. In contrast, as illustrated in FIGS. 3A-3C, the airbag 2 is deployed outward in the width direction, toward the front of the seat 100 but never faces the passenger P until the final stage of the deployment. It is because the length L of the tether 3 is shorter than each of the first length₁ and the second length l₂ of the airbag 2, and the tether 3 is coupled to the airbag 2 at the position in front of the passenger P and the position in back of the passenger P in the front-rear direction of the seat 100 when the deployment of the airbag 2 is completed. By this means, it is possible to prevent the airbag 2 from curving or bending to approach the passenger P by the tether 3 until the final stage of the deployment of the airbag 2, that is, until the vigorous motion of the expanding front portion 22 of the airbag 2 in various directions nearly ends. Therefore, it is possible to reduce the risk of hitting the passenger P against the airbag 2.

Moreover, with the examples illustrated in FIGS. 1A-1B., 2A and 2C, and 3A-3C, in the case where the second end 32, 322 of the tether 3, 302 is coupled to the storage member 6 or the seat back 102 as an adjacent member, when the airbag 2 deploys, the tether 3, 302 is approximately parallel to the front-rear direction of the seat 100. In this way, the tether 3, 302 is approximately parallel to the front-rear direction of the seat 100 when the deployment of the airbag 2 is completed. Consequently, it is possible to prevent the tether 3, 302 from contacting the upper body of the passenger P. In addition, the tether 3, 302 is coupled to the adjacent member such as the storage member 6 and the seat back 102 at a predetermined position (position B, B″) outside the upper body of the passenger P in the seat width direction. By this means, it is possible to more effectively prevent the tether 3, 302 from contacting the upper body of the passenger P. Here, for example, by preventing the tether 3 from contacting the upper body of the passenger P, the tether 3 tends to be approximately parallel to the front-rear direction of the seat 100 as described above, or the front portion of the tether 3 tends to face inward in the seat width direction. In a case where the tether 3 is in this state when the deployment of the airbag 2 is completed, the expanded front portion 22 comes closer to the passenger P, and therefore it is possible to improve the passenger protection performance of the airbag 2 near the passenger P.

In addition to the above-described examples, the airbag may Protrude toward the lower body of the passenger from the seat cushion at a position outside the passenger P in the seat width direction, and then the front portion of the airbag is turned inward in the seat width direction by the tether to deploy above the lower body of the passenger. With this example, it is preferred that the length of the tether from the first end to the second end or an adjacent member is shorter than each of the first length and the second length of the airbag. By this means, the front portion of the airbag is larger than the base portion, and consequently it is possible to increase the area to cover the lower body of the passenger in the seat width direction.

Thus, the airbag protruding from the seat cushion covers the upper part and the side part of the lower body of the passenger, and therefore it is possible to protect the lower body of the passenger from various types of collisions, such as a frontal collision, a lateral collision, a rear collision, and an oblique collision only by the components of the seat.

In addition, in a case where the airbag is deployed upward from the seat cushion, when the second end of the tether is coupled to an adjacent member, it is preferred that the tether is approximately parallel to the vertical direction of the seat. In this way, the tether 3 is approximately parallel to the vertical direction of the seat, and therefore it is possible to prevent the tether from contacting the lower body of the passenger. Moreover, it is preferred that tether is coupled to an adjacent member at a position outside the lower body of the passenger P in the seat width direction. By this means, it is possible to more effectively prevent the tether from contacting the lower body of the passenger P, and the expanded front portion 22 comes closer to the passenger P. Consequently, it is possible to improve the passenger protection performance of the airbag 2 near the passenger P.

As described above, the passenger protection apparatus 1, 11, 12 according to the examples illustrated in FIGS. 1A-1B to 3A-3C can deploy the airbag 2 near the passenger P, by curving or bending the airbag 2 having protruded from the seat 100 in a direction different from thee of the passenger P. In the future, it is possible to turn the seat 100 in various directions in an automated driving vehicle, not only in the direction in which the seat 100 faces the front of the vehicle. In addition, the seat 100 may be disposed in various positions. If so, however, a conventional passenger protection device such as an airbag which may be disposed in various interior materials might not provide the conventional passenger protection performance for the passenger P sitting on the movable seat 100. In contrast, with the passenger protection apparatus 1, 11, 12 according to the above-described examples, the airbag 2 deploys from the seat 100 to surround the passenger P in the area near the passenger P, and therefore it is possible to prevent a decrease in the passenger protection performance even though the seat 100 is disposed in any direction and any position.

Although the example of the present invention has been described, it will be appreciated that the present invention is not limited to the descriptions and drawings of the example. Other examples practiced by persons skilled in the art based on the example, and techniques to use the example are covered by the scope of the present invention.

1. A passenger protection apparatus for a vehicle comprising:
an airbag configured to protrude to a vehicle compartment from a seat on which a passenger sits or a peripheral member of the seat at a predetermined position; and
a tether having a first end and a second end, the first end being coupled to the airbag at a position inward in a seat width direction, and the second end being coupled to an adjacent member adjacent to the airbag or the airbag at a position where the seat is closer to the second end than the first end, wherein:
a length of the tether from the first end to the second end or the adjacent member is shorter than a first length from a position at which the first end is coupled to the airbag to the predetermined position or the second end, and also shorter than a second length from the position at which the first end is coupled to the airbag to a front end of the airbag; and
the first length is shorter than the second length.

2. The passenger protection apparatus for a vehicle according to claim 1, wherein the airbag protrudes from the seat at the predetermined position, and the airbag deploys via a surface of the seat.

3. The passenger protection apparatus for a vehicle according to claim 2, wherein:
the airbag protrudes from a seat back at a position outside an upper body of the passenger in the seat width direction, toward a front of the seat; and
a front portion of the airbag is turned inward in the seat width direction by the tether to deploy in front of the upper body of the passenger.

4. The passenger protection apparatus for a vehicle according to claim 3, wherein in a case where the second end of the tether is coupled to the adjacent member, when the airbag deploys, the tether is approximately parallel to a front-rear direction of the seat.

5. The passenger protection apparatus for a vehicle according to claim 2, wherein:
the airbag protrudes upward from a seat cushion at a position outside a lower body of the passenger in the seat width direction; and
a front portion of the airbag is turned inward in the seat width direction to deploy above the lower body of the passenger.

6. The passenger protection apparatus for a vehicle according to claim 5, wherein in a case where the second end of the tether is coupled to the adjacent member, when the airbag deploys, the tether is approximately parallel to a vertical direction of the seat.

7. The passenger protection apparatus for a vehicle according to claim 1, wherein the tether is coupled to the adjacent member at a position outside an upper body or a lower body of the passenger in the seat width direction.

8. The passenger protection apparatus for a vehicle according to claim 2, wherein the tether is coupled to the adjacent member at a position outside an upper body or a lower body of the passenger in the seat width direction.

9. The passenger protection apparatus for a vehicle according to claim 3, wherein the tether is coupled to the adjacent member at a position outside an upper body or a lower body of the passenger in the seat width direction.

10. The passenger protection apparatus for a vehicle according to claim 4, wherein the tether is coupled to the adjacent member at a position outside an upper body or a lower body of the passenger in the seat width direction.

11. The passenger protection apparatus for a vehicle according to claim 5, wherein the tether is coupled to the adjacent member at a position outside an upper body or a lower body of the passenger in the seat width direction.

12. The passenger protection apparatus for a vehicle according to claim 6, wherein the tether is coupled to the adjacent member at a position outside an upper body or a lower body of the passenger in the seat width direction.
